(19) United States
(12) Patent Application Publication
(10) Pub. No.: US 2010/0206664 A1
(43) Pub. Date: Aug. 19, 2010

(54) Acoustic panel

(75) Inventor: Adam M. Bagnall, Alderwasley (GB)

Correspondence Address: OLIFF & BERRIDGE, PLC, P.O. BOX 320850, ALEXANDRIA, VA, 22320-4850, US

(73) Assignee: ROLLS-ROYCE PLC, LONDON (GB)

(21) Appl. No.: 12/659,339

(22) Filed: Mar. 4, 2010

Related U.S. Application Data
(63) Continuation-in-part of application No. 12/216,423, filed on Jul. 3, 2008, now abandoned.

(30) Foreign Application Priority Data
Jul. 12, 2007 (GB) 0713526.2

(51) Int. Cl. B64D 33/02

(52) U.S. Cl. 181/214

(57) ABSTRACT

An acoustic panel for a fan casing of a gas turbine engine includes one or more Helmholtz resonators to absorb acoustic energy propagated upstream from the fan. By arranging that the periodic air flow out of the resonators has some axial momentum, by inclining the passages that exit from the necks of the resonators in a downstream direction, some of the energy in this air flow can be realised as a useful pressure rise in the direction of the air flow into the fan, rather than a pressure drop as in known acoustic panels.

This is a Continuation-in-Part of application Ser. No. 12/216,423 filed Jul. 3, 2008. The disclosure of the prior application is hereby incorporated by reference herein in its entirety.

This invention relates to ducts carrying flowing gases, and more particularly to arrangements for reducing noise in such ducts. It is envisaged that the invention will be particularly suitable for use in the fan casings of gas turbine engines, though it may equally well be used in other fields.

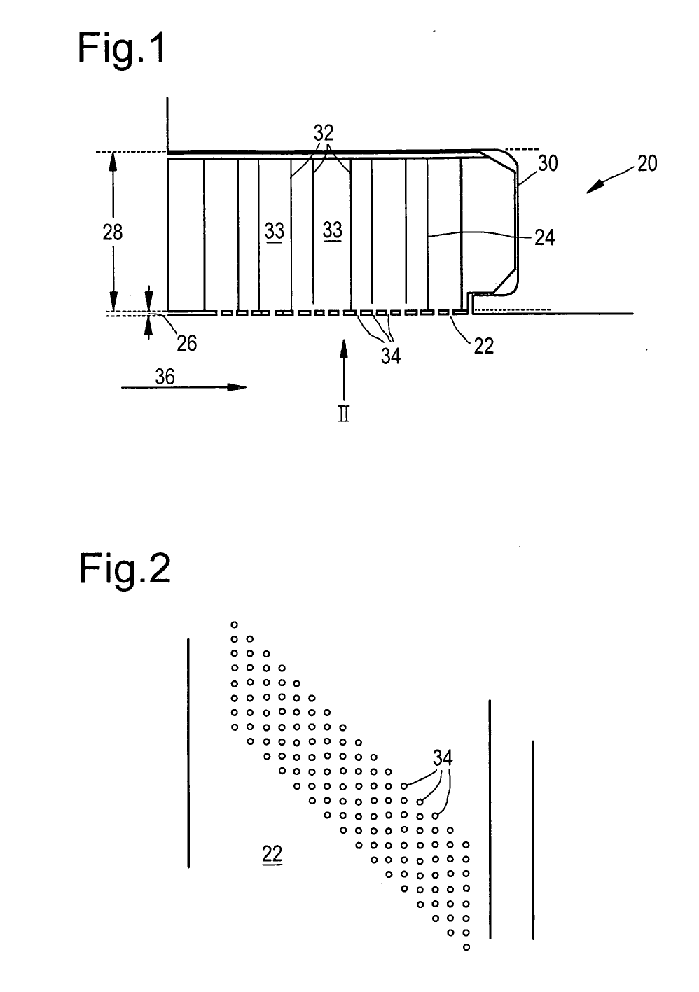

Existing aero engines may incorporate an acoustic treatment in the fan case upstream of the fan to absorb some of the acoustic energy generated by the fan blades. Typically this acoustic treatment consists of a rigid facing sheet, which is perforated with holes perpendicular to the surface and is supported by a honeycomb or pocketed material. The acoustic treatment may also be used to damp an aero-acoustic vibration of the fan blades, commonly called flutter. An example of such a treatment is shown in FIGS. 1 and 2, and it is described in more detail later.

Such acoustic treatments operate in a widely varying pressure field, close to and upstream of the fan. During operation of the engine, the varying static pressure field causes air to flow alternately in and out of the holes of the perforated sheet. Due to the pressure variation, the velocity of this air flow into and out of the holes can be significant compared with the velocity of the boundary layer flow entering the fan. The momentum of the air ejected from the holes is perpendicular to the mainstream flow and results in a pressure loss in the air flow into the fan. The non-optimum dissipation of energy into the air stream adversely affects the properties of the boundary layer of the mainstream air flow entering the fan. This, in turn, has a detrimental effect on the fan system's performance, specifically its stability and efficiency.

It would therefore be desirable to have an acoustic treatment for a fan case that can absorb the acoustic energy generated by the fan blades, without causing a detrimental pressure drop in the boundary layer of the air flow into the fan, with the consequent adverse effects on the fan system performance. It is an objective of this invention to provide such an acoustic treatment.

According to the present invention, there is provided an acoustic panel and an arrangement for absorbing noise energy as set out in the claims.

Embodiments of the invention will now be described, by way of example only, making reference to the accompanying drawings in which:

FIG. 1 is a cross-sectional view of an acoustic treatment of known type;

FIG. 2 is a view in the direction II in FIG. 1;

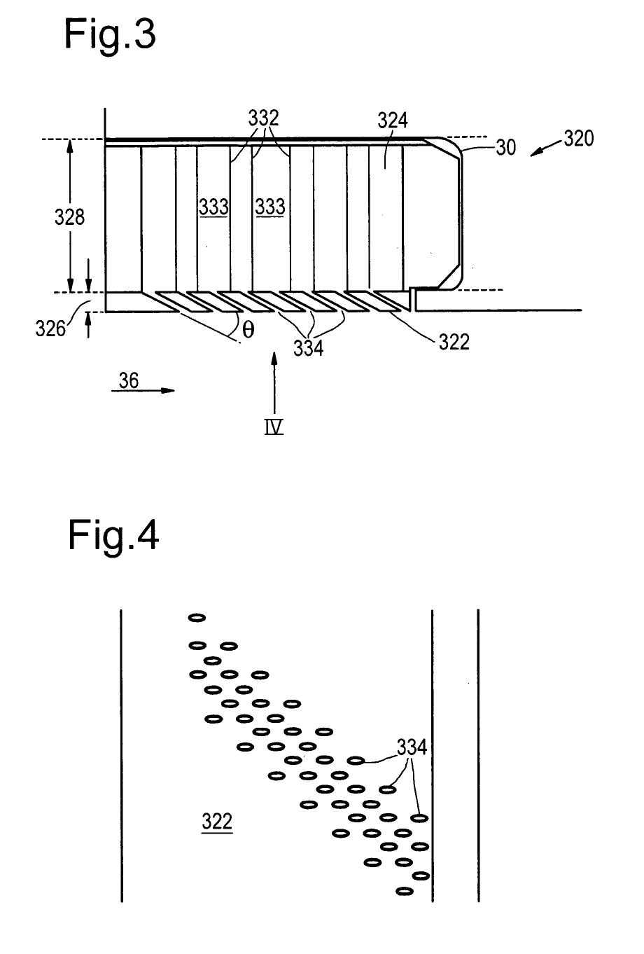

FIG. 3 is a cross-sectional view of a first embodiment of an acoustic treatment according to the invention;

FIG. 4 is a view in the direction IV in FIG. 3;

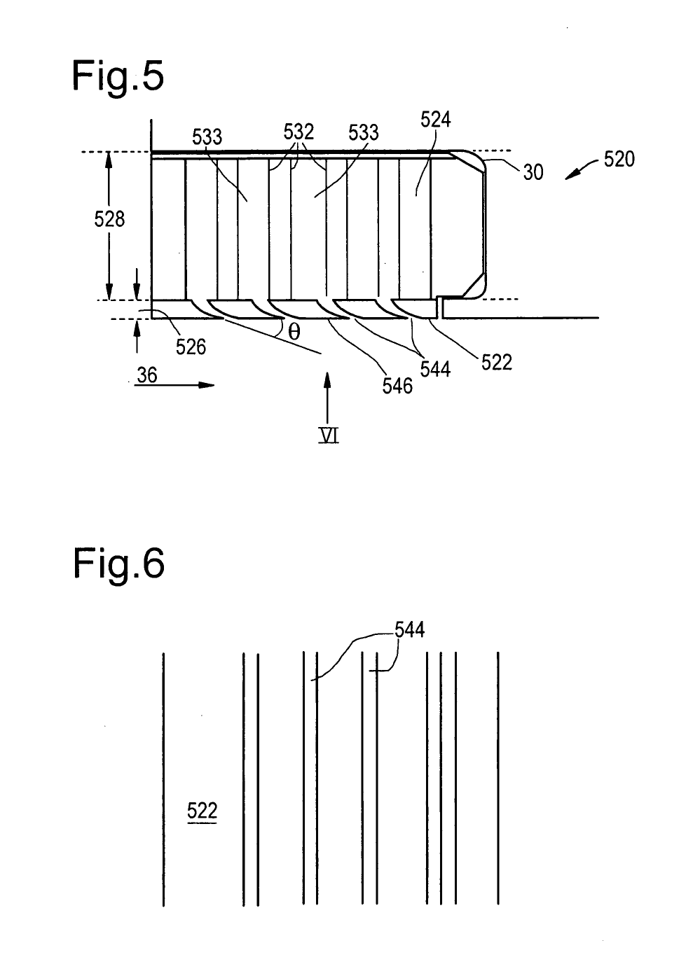

FIG. 5 is a cross-sectional view of a second embodiment of an acoustic treatment according to the invention;

FIG. 6 is a view in the direction VI in FIG. 5;

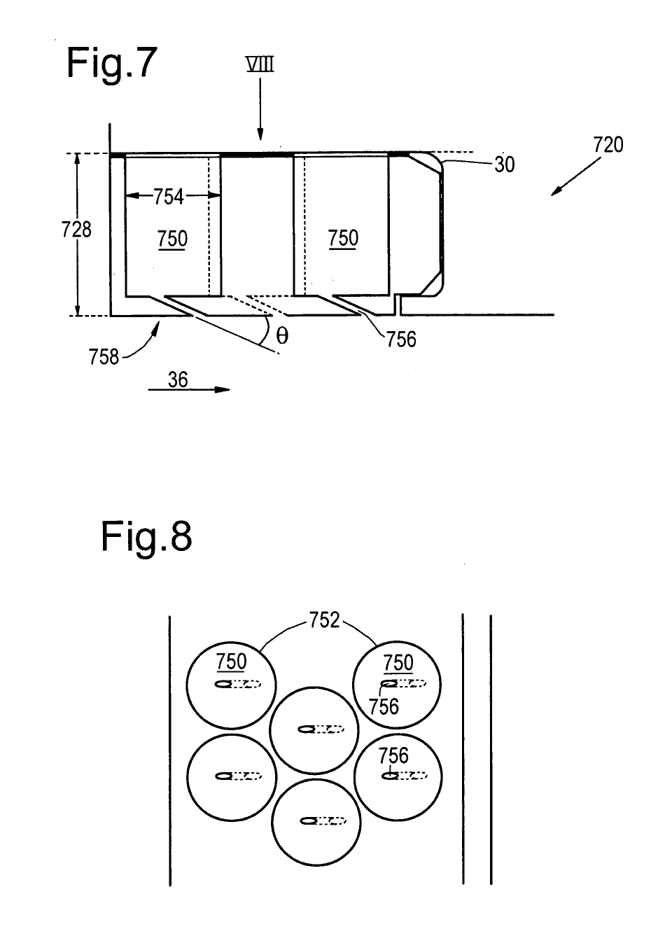

FIG. 7 is a cross-sectional view of a third embodiment of an acoustic treatment according to the invention;

FIG. 8 is a view in the direction VIII in FIG. 7;

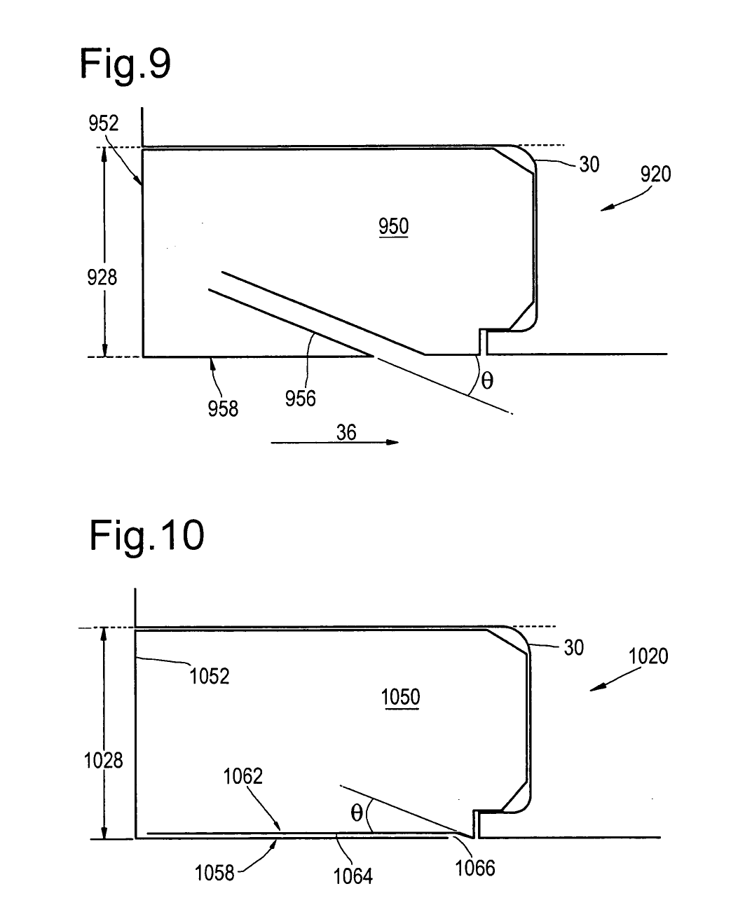

FIG. 9 is a cross-sectional view of a fourth embodiment of an acoustic treatment according to the invention;

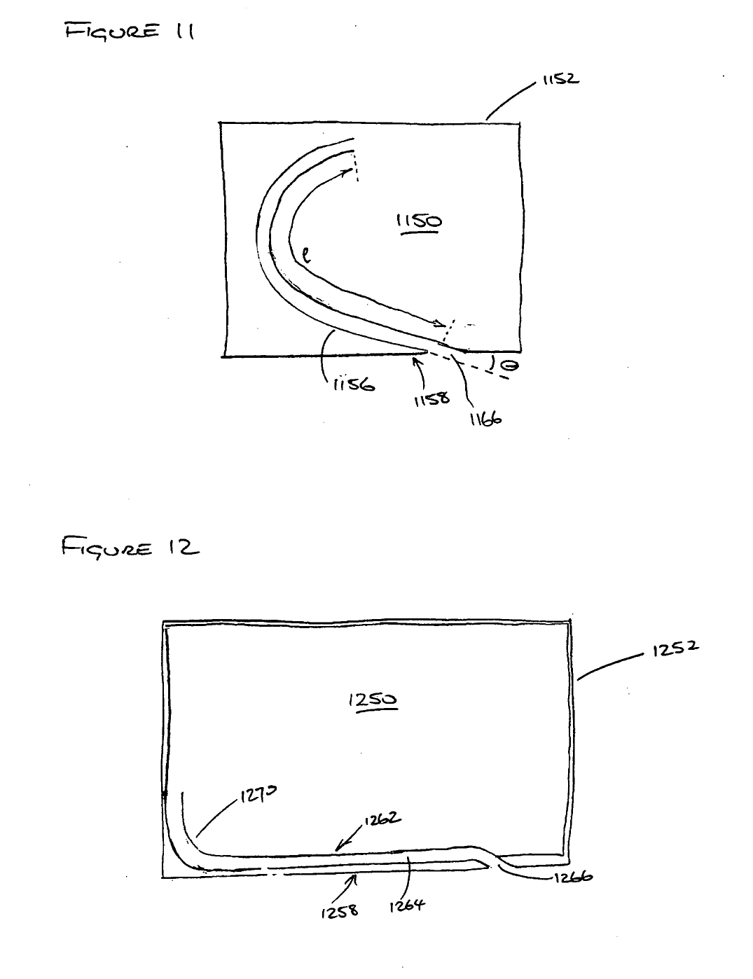

FIG. 10 is a cross-sectional view of a fifth embodiment of an acoustic treatment according to the invention;

FIG. 11 is a cross-sectional view of an alternative arrangement of the acoustic treatment of FIG. 9;

FIG. 12 is a cross-sectional view of an alternative arrangement of the acoustic treatment of FIG. 10;

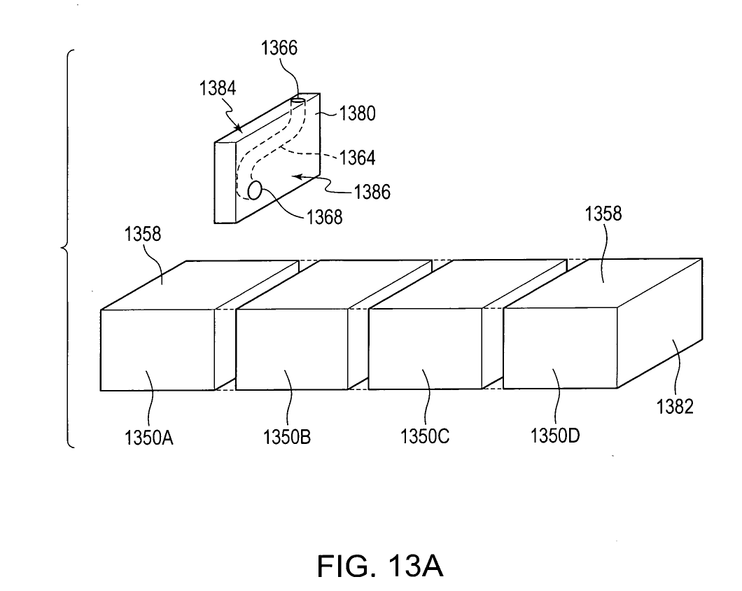

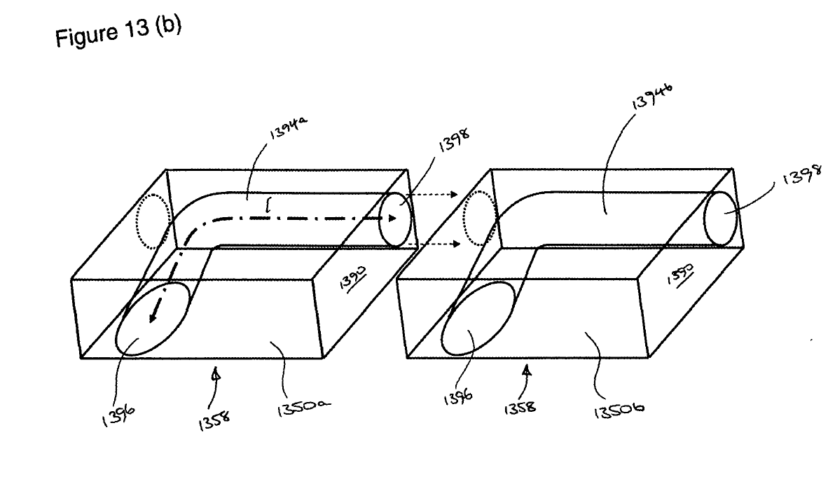

FIG. 13(a) and (b) are schematic views of alternative designs of a sixth embodiment of an acoustic treatment according to the invention; and

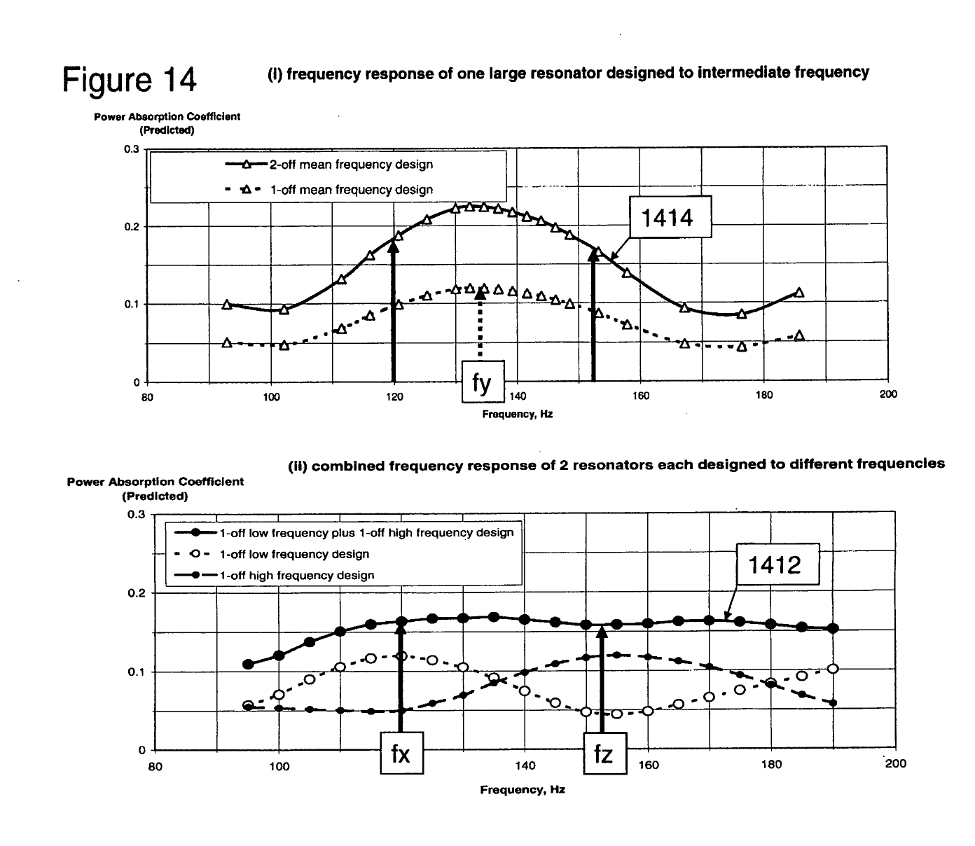

FIG. 14 is an illustration of the noise attenuation achieved by two alternative arrangements of acoustic treatments.

Referring first to FIGS. 1 and 2, an acoustic panel shown generally at 20 comprises a perforated face sheet 22 covering a panel of honeycomb material 24. The thickness 26 of the face sheet 22 is about 1 millimetre, and the depth 28 of the honeycomb material 24 is about 40 millimetres. In use, a number of such panels 20 are mounted in an annular fan casing 30 of a gas turbine engine. The details of this mounting are not important to the understanding of the invention.

Cell walls 32 of the honeycomb material 24 define cells 33, which in use are orientated in a generally radial direction. The face sheet 22 is perforated by a large number of circular holes 34, arranged in a regular pattern over substantially the whole area of the face sheet 22 (in FIG. 2, only a representative sample of the holes 34 is shown). The diameter of the holes 34 is about 1 millimetre. The holes 34 are perpendicular to the surface of the face sheet 22.

In use, a mainstream air flow flows through the annular duct defined by the acoustic panels 20, in the direction shown by the arrow 36. The intake of the gas turbine engine is upstream of the acoustic panels 20 and the fan is downstream of the acoustic panels 20. At the sides of the duct, near to the face sheets 22 of the acoustic panels 20, a boundary layer flow will form, the behaviour of which will be understood by a skilled person. The velocity of the air flow in the boundary layer will be somewhat lower than the velocity away from the sides of the duct.

In use, the static pressure near to the face sheet 22 of a given acoustic panel 20 is subjected to a wide periodic variation, as the fan blades rotate and pass by the panel 20 in turn. With each pressure rise, air will flow from the duct through the holes 34 into the cells 33, and with each pressure fall air will flow out of the cells 33 through the holes 34 and back into the duct. The dimensions of the cells 33 are selected, at the design stage of the acoustic panel 20, to allow each cell 33 to act as a Helmholtz resonator. The resonant frequencies of the cells 33 are designed to absorb some of the energy from the pressure variations, thereby reducing the noise transmitted upstream from the fan.

The behaviour of Helmholtz resonators is well understood, and is defined by the equation

$$f = \frac{c}{2 π} \sqrt{\frac{a}{lV}}$$

in which f is the resonant frequency of the resonator, c is the local speed of sound, a is the cross-sectional area of the hole, l is the effective length of the hole or passage linking the duct and the resonator and V is the volume of the resonator. Due to the magnitude of the pressure variations, the velocity of the air flow into and out of the holes 34 can be significant compared to the velocity of the boundary layer flow entering the fan. The momentum of this fluid ejected from the holes is perpendicular to the mainstream flow 36 and will be realised as a pressure loss in the direction 36 of the air flow into the fan. This non-optimum dissipation of energy into the air stream adversely affects the properties of the boundary layer of the mainstream air flow into the fan. This, in turn, has a detrimental effect on the fan system's performance—specifically its stability and efficiency—compared to a fan system whose annulus wall does not have the pressure loss associated with the acoustic panels.

FIGS. 3 and 4 show a first embodiment of an acoustic panel 320 according to the invention. The panel 320 is mounted in use in a fan casing 30 of a gas turbine engine, as for the prior art acoustic panel shown in FIG. 1.

A panel of honeycomb material 324, whose depth 328 is about 40 millimetres, comprises cell walls 332 defining cells 333. The honeycomb material 324 is covered by a face sheet 322, whose thickness 326 is about 5 millimetres. The face sheet 322 is perforated by a large number of circular holes 334 inclined at an angle θ of about 30 degrees to the surface of the face sheet 322. The diameter of the holes 334 is about 1 millimetre.

In use, a mainstream air flow flows through the annular duct defined by the acoustic panels 320, in the direction shown by the arrow 36. As in the prior art embodiment of FIG. 1, air will flow through the holes 334 into and out of the cells 333 as the duct static pressure rises and falls. As before, the dimensions of the cells 333 are selected, at the design stage of the acoustic panel 320, to allow each cell 333 to act as a Helmholtz resonator.

Because the holes 334 are inclined in a downstream direction, the air flowing out of the cells 333 into the boundary layer of the mainstream air flow into the fan has some axial momentum. In this way some of the energy associated with the velocity of the air exiting the holes 334 is realised as a pressure rise, rather than being dissipated as a pressure loss, in the direction 36 of air flow into the fan.

This exchange of momentum as a useful pressure rise will only occur as the air flows out of the cells 333 of the acoustic panel 320: as the air alternately enters the cells 333 the air is removed from the mainstream flow without a pressure loss to the mainstream flow.

In this respect the invention can be considered as a rectifier whereby some of the acoustic energy, having been converted into kinetic energy associated with the movement of air into and out of the holes 334, is then recovered as a pressure rise in a direction useful to the boundary layer of the mainstream flow into the fan.

The increase in momentum of the boundary layer flow will improve the pressure recovery of the air entering the fan with an improvement to the engine cycle. In addition, there will be a reduction of the blockage associated with the boundary layer entering the fan and so increase the fan's flow capacity with additional benefits to the engine cycle. Furthermore, the increase in momentum of the boundary layer fluid should improve the tip flow of the fan, with additional benefits to the aerodynamic performance of the fan especially in terms of efficiency and stability, including fan stall and fan flutter.

FIGS. 5 and 6 show a second embodiment of an acoustic panel 520 according to the invention. As before, the acoustic panel 520 is mounted in use in a fan casing 30. The acoustic panel 520 comprises a layer 524 of honeycomb material about 40 millimetres deep, with cell walls 532 defining cells 533.

In this embodiment, the honeycomb material 524 is covered by a face sheet 522 which comprises a number of slots 544. The thickness 526 of the face sheet is about 5 millimetres. In this embodiment the slots 544 extend across the whole width of each panel 520, but in other embodiments they may be non-continuous. The part of the slot 544 adjacent to the surface 546 of the face sheet 522 is inclined downstream at an angle θ of about 30 degrees to the surface 546.

It will be appreciated that this arrangement will operate in use in much the same way as the previous embodiment of FIGS. 3 and 4, such that the air flowing out of the cells 533 through the slots 544 into the boundary layer of the mainstream air flow has some axial momentum, which will be realised as a pressure rise in the direction 36 of air flow into the fan.

In this embodiment, a number of slots 544 may be provided, as described above, in a face sheet 522. Alternatively, a plurality of discrete relatively long, narrow slats may be mounted across the cells 533, spaced apart so as to define the slots 544 between them. The slats may be mounted adhesively or by any other suitable means.

The slots could also be defined by laminating a number of thinner strips or slats in each position, to build up the desired thickness 526. Successive strips or slats may be offset to define the curved profile within each slot.

Because the slots 544 of this embodiment extend circumferentially around the wall of the duct, they are expected to be less damaging to, as well as less damaged by, a rubbing fan blade than a large number of smaller, discrete holes would be. Furthermore, the circumferential symmetry of the slots is expected to provide cleaner aerodynamic behaviour in the duct.

FIGS. 7 and 8 show a third embodiment of an acoustic panel 720 according to the invention. As in the previous embodiments, the acoustic panel 720 is mounted in use in a fan casing 30.

The acoustic panel 720 comprises a number of discrete cylindrical chambers 750 defined by walls 752. Each chamber has a diameter 754 of about 25 millimetres. Each chamber is in fluid communication with the duct, in which flows the mainstream air flow 36, via a circular tube 756 with a diameter of about 1 millimetre. The tubes are inclined downstream at an angle θ of about 30 degrees to the surface 758. The overall length 728 (in the radial direction) of the chambers 750 and tubes 756 is about 40 millimetres. The surface 758 provides a smooth air-washed surface in the duct.

The acoustic panel 720 is preferentially machined from a solid plate or block of material. Each chamber 750 is machined as a blind hole (in the downward direction in FIG. 7), and then a circular tube 756 is machined (in a generally upward direction in FIG. 7) to connect to it.

Each chamber 750 will act, in use, as a Helmholtz resonator, with the tube 756 as the resonator neck. As in previous embodiments, the resonant frequency of the chamber 750 will be designed, by suitable choice of the dimensions of the chambers 750 and tubes 756, to deliver the desired attenuation of the acoustic energy generated by the fan.

As in the previous embodiments, the air flowing out of the chambers 750 in use, through the tubes 756 and into the boundary layer of the mainstream air flow, will have some axial momentum, which will be realised as a pressure rise in the direction 36 of air flow into the fan.

FIG. 9 shows a fourth embodiment of the invention, in which the acoustic panel 920 comprises a fabricated chamber 950 defined by walls 952. The depth 928 of the chamber in this embodiment is about 40 millimetres. In use, a number of such chambers would be arranged around an annular fan casing 30. In this embodiment, the inner wall 958 of the chamber 950 forms the air-washed surface of the duct, but the skilled person will appreciate that other arrangements are possible in which an additional component provides the air-washed surface. A tube 956, inclined at an angle θ of about 30 degrees to the surface 958, extends from the surface 958 into the chamber 950. The diameter of the tube 956 is about 7.5 millimetres.

As in previous embodiments, the chamber 950 forms a Helmholtz resonator, and its shape and size are chosen to optimise the attenuation of acoustic energy.

Once again, because of the downstream inclination of the tube 956, air flowing out of the chamber 950 into the boundary layer of the mainstream air flow will have some axial momentum, which will be realised as a pressure rise in the direction 36 of air flow into the fan.

A further advantage of this embodiment of the invention is that the orientation of the tube 956, at angle θ, increases the available length of the tube (l in the equation above) for a given cell size. It will be seen from this equation that a larger l enables a larger a, without affecting the resonant frequency of the resonator. The advantage of increasing the cross-sectional area, a, of the tube is to increase the ability of the resonator to absorb acoustic energy, at frequencies at or close to its resonant frequency.

It will be appreciated that further increases in tube length can be achieved with a compound angle of inclination by utilising an additional component of inclination in and out of the page which would not be apparent in the view shown in FIG. 9.

FIG. 10 shows a fifth embodiment of the invention. As in the embodiment of FIG. 9, the acoustic panel 1020 comprises a fabricated chamber 1050 defined by walls 1052. The depth 1028 of the chamber is about 40 millimetres. In use, a number of such chambers would be arranged around an annular fan casing 30.

The chamber 1050 has a double wall 1058, 1062, defining a passage 1064 which acts in use as the neck of the Helmholtz resonator formed by the chamber 1050. The opening 1066 at the outer end of this passage 1064 is inclined at an angle θ of about 30 degrees to the surface 1058. Because of the inclination of this opening 1066, it will be appreciated that (as in the previous embodiments) the air flowing out of the chamber 1050, through the passage 1064 and into the boundary layer will have some axial momentum, which will be realised as a pressure rise in the direction 36 of air flow into the fan.

As in the embodiment of FIG. 9, this arrangement permits the passage 1064 to be longer than if it were perpendicular to the surface 1058. This in turn enables the cross-sectional area of the passage to be made larger.

FIG. 11 shows an alternative arrangement of the embodiment of FIG. 9. As before, a chamber 1150 is defined by walls 1152. A tube 1156, whose opening 1166 is inclined at an angle θ of about 30 degrees to the surface 1158, extends from the surface 1158 into the chamber 1150. Because the tube 1156 is curved, it will be appreciated that a greater length l can be accommodated within the chamber 1150 than if the tube were straight, as in the embodiment of FIG. 9. As explained above, increasing the length l of the tube enables its cross-sectional area a to be increased without affecting the resonant frequency of the resonator. The advantage of increasing the cross-sectional area, a, of the tube is to increase the ability of the resonator to absorb acoustic energy, at frequencies at or close to its resonant frequency.

FIG. 12 shows an alternative arrangement of the embodiment of FIG. 10. A chamber 1250 is defined by walls 1252. As in FIG. 10, a double wall 1258, 1262 defines a passage 1264 which acts in use as the neck of the Helmholtz resonator formed by the chamber 1250. The opening 1266 at the outer end of this passage 1264 is inclined at an angle θ of about 30 degrees to the surface 1258. In contrast to the embodiment of FIG. 10, the passage 1264 has a curved portion 1270. As in the embodiment of FIG. 11, this advantageously permits a longer neck to be accommodated within the Helmholtz resonator formed by the chamber 1250.

It will be appreciated that the arrangements shown in FIGS. 11 and 12 are only examples, and that other implementations of the curved tube or passage would deliver similar advantages.

FIG. 13(a) illustrates a further embodiment of an acoustic treatment according to the invention. The acoustic treatment in this embodiment comprises a succession of chambers 1350a, 1350b, 1350c, 1350d, each of which is essentially a box. The chambers 1350 may be formed of plastics material. The chambers 1350 may be formed individually, or several may be formed as a single piece (somewhat like a rectangular pipe), for example by extrusion. This is shown by the dashed lines in FIG. 13. As in the previous embodiments, the chambers 1350 will act in use as Helmholtz resonators. In use the chambers 1350 will form part of an acoustic panel, and the surfaces 1358 will form the air-washed surfaces of the duct as in previous embodiments.

The solid block 1380 has a passage 1364 formed within it. The passage has an opening 1366 on a side face 1384 of the block 1380, and an opening 1368 on an end face 1386 of the block 1380. In use, the block 1380 fits into the space between two adjacent chambers, for example between 1350a and 1350b. The opening 1368 is then in fluid communication with chamber 1350b, and the opening 1366 (and the side face 1384) will essentially form a part of the air-washed surface 1358. The passage 1364 will therefore act as the neck of the Helmholtz resonator formed by the chamber 1350b. Further blocks 1380 will be fitted between the other adjacent pairs of chambers 1350, and may be secured by any suitable means, for example by ultrasonic welding.

As in previous embodiments, it will be appreciated that the curved shape of the passage 1364 permits a longer neck to be accommodated within the dimensional constraints of the block 1380, and the passage 1364 may be made more or less tortuous as circumstances require.

In the case where several chambers 1350 are extruded in a single piece, it may be more convenient for the blocks 1380 to be introduced through an open end 1382 and slid along inside the chambers 1350 to their correct positions. They can then be secured in place.

FIG. 13(b) illustrates an alternative arrangement of the embodiment shown in FIG. 13(a). Chambers 1350a and 1350b, similar to those in FIG. 13(a), each act in use as Helmholtz resonators. As in FIG. 13(a), the surfaces 1358 (underneath the chambers 1350 in FIG. 13(b)) will form part of the air-washed surface of the duct in use.

In contrast to the arrangement of FIG. 13(a), ducts 1394a and 1394b are attached within the chambers 1350a and 1350b. Each duct has an opening 1396, in the surface 1358 and (as in other embodiments) at an angle of about 30 Degrees to it. An opening 1398, at the other end of the duct, is provided in an end wall 1390 of each chamber. As explained before, the opening 1398 may advantageously be flared to reduce losses. The ducts 1394a,b are not in fluid communication with their respective chambers 1350a,b.

In use, the chambers 1350a and 1350b will be joined together (and further chambers (not shown) will be joined to them to form an annular array) so that the duct 1394a is brought into fluid communication with the chamber 1350b. In the same way, the duct 1394b will be brought into fluid communication with the next chamber, and so on. The end of each chamber opposite the end wall 1390 may be open (so that the wall 1390 will form the dividing wall between adjacent chambers) or it may be provided with its own end wall, with a hole (as shown by the dotted lines) to accommodate the duct from the adjacent chamber.

This arrangement provides another way to maximise the length l of the tuned port 1394 of the resonator 1350, for a given resonator volume.

An advantage of the arrangements shown in FIGS. 13a and 13b is that its component parts may be readily fabricated, especially from plastics materials, using common manufacturing techniques, thus reducing the cost of manufacturing the acoustic panels.

The skilled reader familiar with Helmholtz resonators will understand that although a given resonator will have a particular resonant frequency f, in practice it will provide damping over a range of frequencies around f (albeit to a lesser extent). FIG. 14 illustrates schematically how this property may be used to advantage in the design of acoustic panels. FIG. 14 shows schematic graphs of noise level against frequency.

Consider the case where it is desired to attenuate two particular frequencies fₓ and f_{z}. In FIG. 14(ii) two relatively small Helmholtz resonators are provided, each tuned to one of the desired frequencies. The resulting attenuation profile is shown by the line 1412, and it will be seen that each of the frequencies fₓ and f_{z} is attenuated by some amount. By contrast, in FIG. 14(i) a single, larger Helmholtz resonator is provided, with a resonant frequency f_{y} intermediate between the two desired frequencies fₓ and f_{z}, but with a broader frequency range. It can be seen from the attenuation profile 1414 that the frequency range of this resonator is broad enough to provide significant attenuation of both target frequencies fₓ and f_{z}, and because of the greater size of the resonator in this case the attenuation achieved is greater than that achieved with 2 separate resonators tuned for each frequency. The choice between a single resonator at an intermediate frequency and separate resonators for more than one frequency will depend on the breadth of frequency response of a single resonator compared to the range of frequencies in need of attenuation.

The invention thus provides an acoustic panel for a fan casing of a gas turbine engine in which one or more Helmholtz resonators are used to absorb acoustic energy propagated upstream from the fan. By arranging that the periodic air flow out of the resonators has some axial momentum, some of the energy in this air flow can be realised as a useful pressure rise in the direction of the air flow into the fan, rather than a pressure drop as in known acoustic panels.

It will be appreciated by the skilled person that the underlying principle of this invention may be applied in many other ways, besides those set out in the specific embodiments described above.

In any of the embodiments, the sizes and shapes of the cells or chambers may be changed to suit particular circumstances. The arrangement or packing of the chambers, for example in the embodiment of FIGS. 7 and 8, may be any convenient arrangement. To facilitate this, or for any other reason, the chambers may be of shapes other than cylindrical. The thickness of the face sheet may be less or greater than in the embodiments described.

In any of the embodiments, the tubes may be non-circular, and it may be advantageous for their cross-sectional area to vary along their length. Specifically, it may be advantageous to flare one or both ends of the tubes. The losses that limit the absorption power are due to the velocity at the ends of the resonating air column. The challenge is to maximise the cross-sectional area at the ends of the tube to maximise its effectiveness, whilst maintaining its resonant frequency; the frequency requires the tube to have a certain ratio of mean effective cross-sectional area to length, for a give volume.

In the embodiments of FIGS. 3, 4, 5 and 6 a pocketed material (in which the volume outside the air-washed surface is divided into a plurality of pockets or smaller volumes or chambers) may be used in place of the honeycomb material.

The sizes and positions of the perforations in the face sheet, in the embodiment of FIGS. 3 and 4, may be different from that shown. Specifically, the pattern of the holes may be chosen to align the holes with the cells of the honeycomb material. Similarly, the sizes and positions of the slots in the embodiment of FIGS. 5 and 6 may be varied, and the slots may be continuous or non-continuous around the circumference of the duct. The passages adjacent to the slots may be curved (as shown in the embodiment of FIGS. 5 and 6) or straight, and may or may not taper towards the slots.

The angle of inclination of the holes, slots or tubes in the various embodiments may be varied to provide the optimum pressure recovery in the air flow. It may be desirable to use different angles of inclination in different axial or circumferential positions, and the angle of inclination may include a circumferential component. It is anticipated that the angle of inclination θ to the duct surface may be up to 45 degrees.

The use of the invention has been described in the context of an acoustic panel for the fan casing of a gas turbine engine. A skilled person will appreciate that the underlying principle of the invention may advantageously be employed in other fields in which a gas flows through a duct and is subjected to pressure fluctuations. Some specific examples are set out, but these are not intended to be limiting.

The invention may be employed in the intake of a gas turbine engine, or in the bypass or exhaust ducting of such an engine.

The invention may be employed in ducts of domestic or commercial air conditioning or ventilation systems, and may be used upstream or downstream of a fan in such a system. It may also be used in air conditioning or ventilation systems in land, sea or air vehicles.

The invention may be used in the intake, exhaust or other ducting of a reciprocating engine.

What is claimed is:

1. An acoustic panel for a duct, the duct having an upstream end and a downstream end, the panel comprising a cavity and further comprising a passage in fluid communication with the cavity and having an opening in fluid communication with the duct in use, at least the opening of the passage being inclined towards the downstream end of the duct so that fluid flow out of the passage has a component of momentum in the downstream direction, wherein the passage comprises a tube and the tube extends into the cavity.

2. An acoustic panel for a duct, the duct having an upstream end and a downstream end, the panel comprising a cavity and further comprising a passage in fluid communication with the cavity and having an opening in fluid communication with the duct in use, at least the opening of the passage being inclined towards the downstream end of the duct so that fluid flow out of the passage has a component of momentum in the downstream direction, wherein the passage comprises a slot.

3. An acoustic panel as claimed in claim 2, wherein the panel comprises a plurality of cavities and the slot extends across at least two cavities.
